(19) United States
(12) Patent Application Publication
(10) Pub. No.: US 2013/0250552 A1
(43) Pub. Date: Sep. 26, 2013

(54) LIGHTED CLIPBOARD

(71) Applicant: Brian Anderson, Meriden, CT (US)

(72) Inventor: Brian Anderson, Meriden, CT (US)

(21) Appl. No.: 13/426,856

(22) Filed: Mar. 22, 2012

(51) Int. Cl. F21V 33/00

(52) U.S. Cl. 362/98

(57) ABSTRACT

A lighted clipboard comprising a platform, where the platform receives a document; a clip attached to a top portion of the platform, where the clip secures the document to the platform; an adjustable light attached to the platform, where the adjustable light is an LED light and where the adjustable light illuminates the document on the platform. The adjustable light may be attached to the top, bottom or sides of the platform for optional illumination of the document.

### BACKGROUND OF THE INVENTION

1. Field of the Invention

The present invention relates to a clipboard that includes an adjustable LED light to illuminate any papers or documents on the clipboard.

2. Description of Related Art

Clipboards are common accessories in an office or work setting, on the sidelines with the coaches or alternatively by people collecting signatures from others on the street. Regardless of the purpose clipboards provide a convenient platform to hold documents when a user is away from a desk or table. The thin, compact size of standard clipboards is easy to store in a bag or briefcase making them such commonly used writing accessories. Typically, the clipboards are used during the day when sufficient overhead light or sunlight is available to allow the user to see the documents on the clipboard. When there is no external light the user has difficulty viewing what is on the clipboard and must move to a location with more ample light to prevent straining their eyes.

Recently, developments have been made to combine an illumination source with the clipboards. For example, U.S. Pat. No. 6,443,588 by Victor M. Nunez discloses a lighted clipboard device wherein an elongated light is attached to the top of the clipboard clip. The light illuminates the papers secured by the clip. Alternatively, U.S. Pat. No. 6,241,360 by Daniel B. Merrell discloses a lighted writing support and clipboard. The light is attached within the clip to shed light on the papers. These devices do assist to prevent eye strain, but are stationary against the clip. Finally, U.S. Pat. No. 6,846,090 by Darryl Smith discloses a back-lighted clipboard with storage container. The clipboard includes a light within the platform itself to illuminate the papers from below instead of from above. A problem with the backlight is that once more and more papers are stacked the back-light will no longer illuminate the papers because too many pages are blocking.

It would be desirable in the art to provide a clipboard that includes a light to illuminate the pages on the platform. It would also be beneficial in the art to provide a clipboard with an adjustable light so that the user may position the light as they desire.

### SUMMARY OF THE INVENTION

In view of the foregoing disadvantages inherent in the prior art, the general purpose of the present invention is to provide an adjustably lighted clipboard, configured to include all of the advantages of the prior art, and to overcome the drawbacks inherent therein.

Accordingly, an object of the present invention is to provide an adjustable light on a clipboard to enable a user to illuminate their documents while using the clipboard.

Another object of the present invention is to provide an adjustable light on a clipboard where the light may be repositioned around the platform to illuminate the documents at an angle of the user's choosing.

To achieve the above objects, in an aspect of the present invention, a lighted clipboard is described comprising a platform, where the platform receives a document; a clip attached to a top portion of the platform, where the clip secures the document to the platform; an adjustable light attached to the platform, where the adjustable light is an LED light and where the adjustable light illuminates the document on the platform. The adjustable light may be attached to the top, bottom or sides of the platform for optional illumination of the document.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings in which:

FIG. 1 depicts a perspective view of a lighted clipboard in accordance with an exemplary embodiment of the present invention.

### DETAILED DESCRIPTION OF THE DRAWINGS

The present invention relates to a clipboard with a light fastened to the top to illuminate the materials attached to the clipboard. The present invention provides a lighted clipboard wherein an adjustable LED light may be positioned atop various clipboards. The light may be adjusted quickly and easily for paperwork illumination.

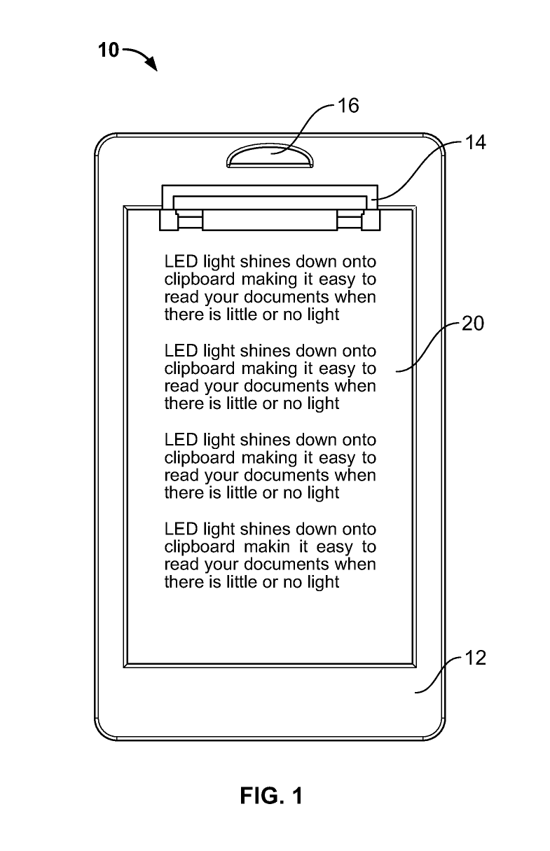

Turning now descriptively to the drawing, FIG. 1 shows a lighted clipboard 10 in accordance with an exemplary embodiment of the present invention. The lighted clipboard 10 includes a platform 12 upon which a user may place their documents 20 like writing, clippings, papers or other items commonly attached to a clipboard. The platform 12 may range in dimension from 8-18 inches long and 4-12 inches wide; preferably the platform is 15 inches long by 9 inches wide. The platform 12 may be made from wood, plastic or a metallic material like aluminum or the like.

Positioned along a top portion of the platform 12 may be a clip 14. The clip 14 secures the documents 20 to the platform 12 to prevent them from sliding during use. The clip 14 may be a wire spring clip (as shown), a plastic C-shaped clip, or a heavy-duty, wall-mountable, metal clip that enables the user to hang the lighted clipboard 10 on a wall or from a hook.

Fastened to by the clip 14 may be an adjustable light 16. The adjustable light 16 may be positioned above or on top of the clip 14 to illuminate the documents 20. Alternatively, the adjustable light 16 may be positioned to the lateral portions or even the bottom of the platform 12 to illuminate the document 20 from the sides or bottom. The adjustable light 16 may be fastened to the platform with a securing means, wherein the securing means may be a clip, snap, glue, kook and loop fasteners or the like to detachably mounting the adjustable light 16 to the platform 12. The angle of illumination on the adjustable light 16 may be changed may twisting or tuning the adjustable light 16 upon the securing means. The adjustable light 16 may be an LED light that is battery operated for convenience.

The lighted clipboard 10 easily illuminates documents 20 on the platform 12 for greater portability and versatility than standard clipboards. The lighted clipboard 10 may be themed with characters, sports teams, animals, and shapes to be appealing to the individual user's particular interests. For example, the lighted clipboard 10 may have themes like Hello Kitty®, Star Wars® or Transformers® to appeal to children or football, basketball and college team logos and mascots to appeal to the avid sports enthusiasts.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A lighted clipboard comprising:
a platform, where the platform receives at least one document;
a clip attached to a top portion of the platform, where the clip secures the at least one document to the platform;
an adjustable light attached to the platform, where the adjustable light is an LED light and where the adjustable light illuminates the at least one document on the platform.

2. The lighted clipboard according to claim 1, wherein the adjustable light includes a securing means to detach and reposition the adjustable light against the platform.

3. The lighted clipboard according to claim 2, wherein the securing means positions the adjustable light against a lateral portion of the platform.

4. The lighted clipboard according to claim 2, wherein the securing means positions the adjustable light to a top portion of the platform.

5. The lighted clipboard according to claim 2, wherein the securing means positions the adjustable light atop the clip.

6. The lighted clipboard according to claim 2, wherein the securing means enables the adjustable light to twist or rotate to modify an angle of illumination cast by the adjustable light upon the at least one document.

7. The lighted clipboard according to claim 1, wherein the platform is made from one of at least plastic, wood and metal.

8. The lighted clipboard according to claim 1, wherein the clip is one of at least a wire spring clip, and a plastic clip.

9. The lighted clipboard according to claim 1, wherein the clip is a heavy-duty, wall-mountable, metal clip to hang the lighted clipboard to a wall.

10. The lighted clipboard according to claim 1, wherein the platform comprises a length of 15 inches and a width of 9 inches.
